(19) United States
(12) Patent Application Publication
(10) Pub. No.: US 2009/0034237 A1
(43) Pub. Date: Feb. 5, 2009

(54) Skate Covering With Integral, Downwardly Projecting LED Illumination System

(76) Inventor: Alfred H. Peckham, JR., Ingalls, IN (US)

Correspondence Address: BOWMAN & ASSOCIATES, 1016 3rd Avenue, SW, Suite #106, CARMEL, IN, 46032, US

(21) Appl. No.: 12/247,296

(22) Filed: Oct. 8, 2008

Related U.S. Application Data
(63) Continuation of application No. 11/517,980, filed on Sep. 8, 2006.

(51) Int. Cl. F21V 21/08

(52) U.S. Cl. 362/103

(57) ABSTRACT

A covering for a skate incorporates a downwardly-directed LED illumination system. The covering is configured to wrap around and/or cover at least the lower portion of the shoe of the skate and may be formed of a flexible material such as cloth, or may be formed of a rigid or semi-rigid material such as a plastic or the like. The LED illumination system includes a first mount situated on a bottom side of the covering so as to be essentially parallel with a skating surface when the covering is situated on the skate and a second mount situated on another bottom side of the covering so as to be essentially parallel with the skating surface when the covering is situated on the skate. Each mount carries a plurality of LEDs so that the LEDs direct emanating light downward onto the skating surface. Circuitry, including a battery, switch and operating components/circuitry/logic, are carried on the inside of the covering and controls the lighting and/or lighting effects of the LEDs. The LEDs may be white, a single color, multiple colors, or any combination thereof.

### RELATED APPLICATIONS

This patent application is a continuation of co-pending U.S. patent application Ser. No. 11/517,980 filed Sep. 8, 2006 entitled “Skate Covering With Integral, Downwardly Projecting LED Illumination System”, the entire contents of which is specifically incorporated herein by reference and of which is claimed the benefit of and/or priority thereto.

### BACKGROUND OF THE INVENTION

1. Field of the Invention

The present invention relates to illumination devices for skates and, more particularly, to a covering for a roller skate that incorporates a downwardly-directed LED illumination system.

2. Background Information

From roller skating to in-line skating to even ice skating, skating is a fun and healthful recreation and/or sport for many adults and children. Skating of all types is gaining in popularity especially because of the recognition of the healthful benefits such activity can bring. With popularity comes ingenuity. Some of such ingenuity has been directed towards providing illumination for skates.

Illumination can provide visual imagery for the skater and for people watching the skater. It can also provide aesthetic enhancement for the skater and/or skate. Moreover, illumination provides a safety factor when used at night. Because of this, various illumination systems have been developed for skates as well as other items such as skateboards, shoes, headbands and gloves.

However, with respect to skates, there are a number of prior art devices that are designed to provide illumination. For instance, U.S. Patent Publication 2004/0125595 by Salatino shows a skate light assembly that is interposed between a boot and the roller track of the skate. The skate light assembly includes a front light and rear light, with the rear light also being a switch. The front light directs light toward the front of the skate while the rear light directs light toward the rear of the skate. U.S. Pat. No. 6,238,055 issued to Wallace shows a powered lighting device for in-line skates and other sporting equipment wherein a battery case holding batteries is attached around the ankle of the skate. A flexible tube is attached to the battery case at one end and to a socket having a light bulb at the other end. The socket is affixed to the side of the skate shoe with a hook and loop material. The light bulb provides a forward directed light. Furthermore, U.S. Pat. No. 5,588,734 issued to Talamo et al. shows a side light for an in-line roller skate. The side light includes a battery housing that is attached around the ankle of the skate and includes a transparent tube holding a plurality of light elements. The tube is attached the side of the wheel mount and include a front light as well as a plurality of side lights. The plurality of side lights provides side illumination of the skating surface. Moreover, U.S. Pat. No. 5,516,149 issued to Moore shows a skate light apparatus that includes a self-contained, battery powered light assembly and an adjustable bracket or an adjustable strap for connecting the light assembly to the skate. The light assembly includes a housing, battery pack, a light source, and a switch. The light assembly may also include a rotatable reflector and an electric motor for rotating the reflector.

Further examples of lighting systems include U.S. Pat. No. 5,513,080 issued to Magle et al. Magle provides an indirect lighting system for roller skates and skateboards. The lighting system is mounted under the shoe section of the skate or on the underside of the skateboard for directing light down from the bottom of the skate/board onto the skating surface. U.S. Pat. No. 5,484,164 issued to McInerney et al. shows an illumination system for roller skates, roller blades (in-line skates) or the like, that has a battery pack mounted to the back of the skate boot and a plurality of lights mounted along the side of the boot between a front headlight and a rear brake light. The lights are integral with the skate boot. The brake light is operable through the brake pad of the skate. The circuit wires may be embedded in the boot. Lastly, U.S. Pat. No. 4,367,515 issued to Beard shows a roller skate light attachment that is operable to be fitted between the toe stop and the toe stop support.

A problem with some of these prior art lighting systems is that they are integral with the skate. Therefore, since they are permanently a part of the skate, they cannot be removed in order to transfer the lighting system to another skate if desired. Moreover, this complicates the ability to repair the lighting system if something should go wrong.

A problem with other skate lighting systems is that they are either attached to the skate in an awkward manner or have components or elements that extend beyond the perimeters of the skate. In both instances, such lighting systems may be easily damaged during normal use. Moreover, such lighting systems can easily become detached from the skate.

In still other cases, the lighting system is more akin to a headlight on a vehicle rather than being aesthetically pleasing in nature.

It is therefore evident from the above that there is a need for a skate lighting/illumination system that can be easily removed and/or transferred to another skate.

It is therefore also evident from the above that there is a need for a skate lighting/illumination system that eliminates or reduces the chance of breakage during use.

It is therefore further evident from the above that there is a need for a skate lighting/illumination system that provides illumination on the skate in an aesthetically pleasing manner.

### SUMMARY OF THE INVENTION

The present invention is a covering for a skate having an integral, downwardly projecting LED illumination system. The covering is configured to wrap around and/or cover the shoe of the skate and may be formed of a flexible material such as cloth, or may be rigid or semi-rigid and formed of a plastic or the like. The LED illumination system includes a first mount situated on a bottom side of the covering so as to be essentially parallel with a skating surface when the covering is situated on the skate and a second mount situated on another bottom side of the covering so as to be essentially parallel with the skating surface when the covering is situated on the skate. Each mount carries a plurality of LEDs so that the LEDs direct emanating light downward onto the skating surface. Circuitry to drive and/or run the LEDs, including a battery and switch, are carried on the inside of the covering and controls the lighting and/or lighting effects of the LEDs.

In one form, the present invention provides a covering for a skate that includes a body formed to cover a shoe portion of a skate, a first board carried on a first bottom side of the body and parallel to a skating surface when the body is situated onto the skate, a first plurality of LEDs carried on the first board and situated thereon to direct light emanating therefrom downwardly toward the skating surface, a second board carried on a second bottom side of the body and parallel to the skating surface when the body is situated onto the skate, a second plurality of LEDs carried on the second board and situated thereon to direct light emanating therefrom downwardly toward the skating surface, and circuitry connected to the first and second plurality of LEDs and adapted to drive the first and second plurality of LEDs.

The present invention will be more apparent upon reading the following detailed description in conjunction with the accompanying drawings.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective view of a roller skate having an exemplary embodiment of a skate covering with an integral, downwardly projecting LED illumination system fashioned in accordance with the present principles;

FIG. 2 is a bottom view of the roller skate of FIG. 1 having the present exemplary skate covering with the integral, downwardly projecting LED illumination system thereon particularly illustrating a manner in which the covering is retained onto the skate;

FIG. 3 is a rear view of the roller skate of FIG. 1 having the present exemplary skate covering with the integral, downwardly projecting LED illumination system thereon particularly illustrating a manner in which the covering is retained onto the skate;

FIG. 4 is a perspective underside view of the present exemplary skate covering with the integral, downwardly projecting LED illumination system;

FIG. 5 is a perspective underside view of another exemplary skate covering with an integral, downwardly projecting LED illumination system fashioned in accordance with the present principles;

FIG. 6 is a perspective view of the skate covering with integral, downwardly projection LED illumination system of FIG. 6 illustrating a manner in which the skate covering is placed on a roller skate; and

FIG. 7 is a perspective view of an in-line skate having a skate covering with an integral, downwardly projection LED illumination system fashioned in accordance with the present principles.

Like reference numerals indicate the same or similar parts throughout the several figures.

### DETAILED DESCRIPTION OF THE PREFERRED EMBODIMENTS

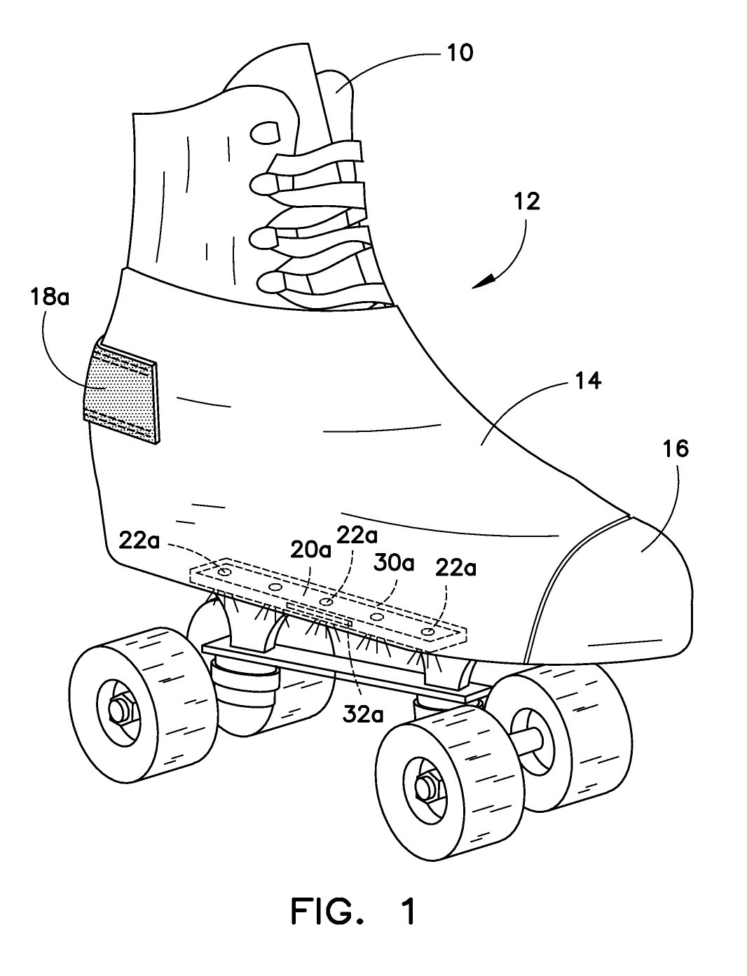

Referring to FIGS. 1-3, there is depicted a typical roller skate 10 on which is disposed a skate covering with an integral, downwardly projecting LED illumination system, generally designated 12, fashioned in accordance with the present principles. The skate covering 12 is configured, adapted and/or operable to provide, in addition to other features, aesthetically pleasing illumination emanating from the underside of the skate 10. Particularly, the skate covering 12 provides downwardly projecting illumination or light of one or more colors, of white light, or a combination thereof as desired from right and left undersides of the skate.

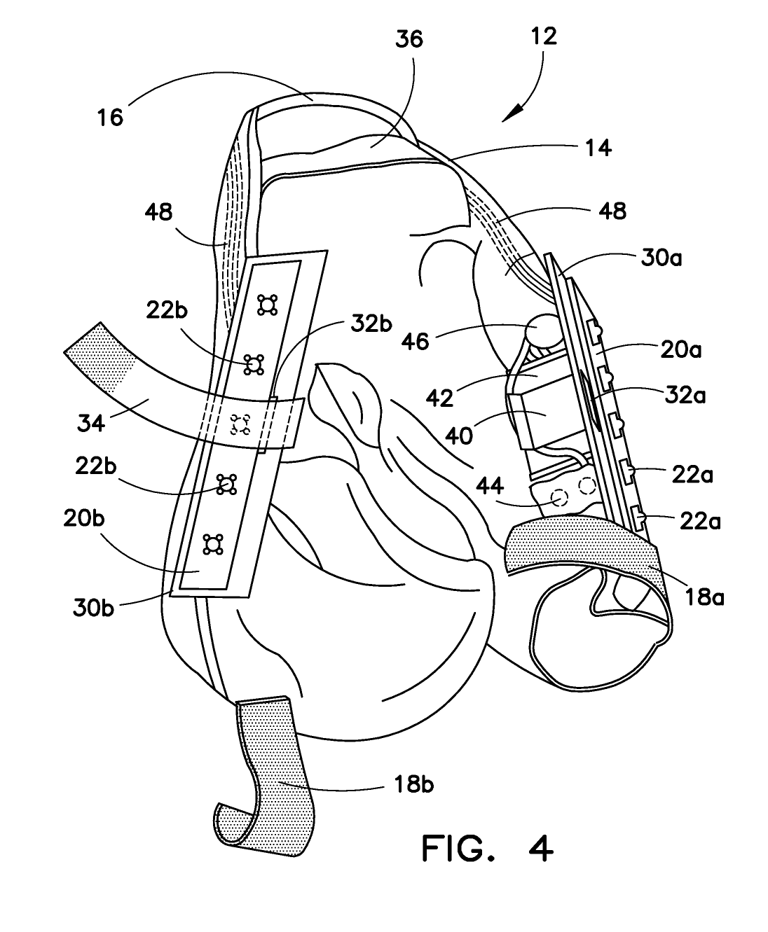

With additional reference to FIG. 4, the covering 12 is defined by a body 14 that, in this embodiment, is fabricated from a flexible material such as cloth. The cloth may also be somewhat stretchable if desired. The body 14 is designed to extend about the shoe portion of the skate 10. Since there are different sizes of skates, the body 14 may be come in different sizes in order to accommodate different sizes of skates. Because the body 14 is made from a cloth or cloth-like material, the covering 12 may include a toe guard 16 that covers the toe area of the covering 12 and thus the toe area of the shoe of the skate 10. The toe guard 16 may be fabricated from a relatively hard and/or durable material such as a plastic or similar material.

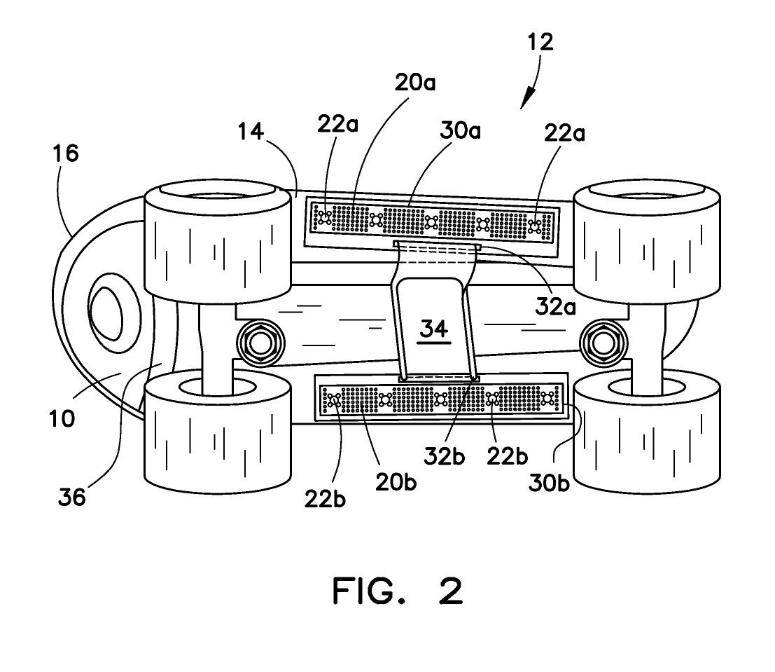

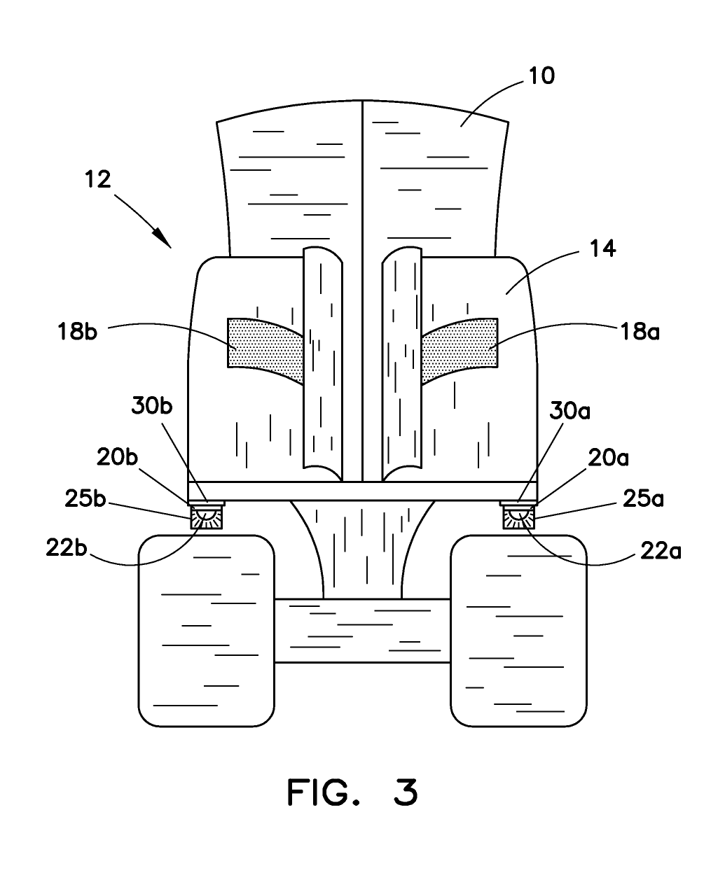

The covering 12 is designed to fit over the shoe of the skate 10 in a toe first manner. Particularly, the toe portion of the body 14 is slipped over the toe portion of the skate shoe and then fastened at the rear or heel of the skate shoe. As best seen in FIG. 2, the body 14 extends over the end of the toe of the shoe of the skate. FIGS. 2 and 4 show an optional toe strap 36 that is configured to fit underneath the toe of the shoe of the skate and beyond the toe stop thereof and which aids in retaining the front or toe part of the covering 12 onto the front part or toe of the shoe of the skate. FIG. 3 illustrates the closing of the rear of the covering 12. Particularly, the rear of the body 14 includes straps 18a, 18b that preferably, but not necessarily, each have a portion of a hook and loop material such as Velcro® that allows the straps 18a, 18b to be releasably attached to one another. The straps 18a, 18b may be fastened together in other manners. Additionally, the rear of the body 14 may not have straps but incorporate a closure mechanism. In FIG. 3, the rear of the covering 12 is shown before closure. In this manner, the covering 12 is retained on the shoe of the skate 10.

FIG. 2 depicts the bottom left and right sides of the covering 12 as the covering 12 fits around and onto the left and right bottom sides of the skate 10. The bottom left side of the covering includes a mount 30a that extends between the front and rear skate wheels. The mount 30a is rigid and may be fabricated from a plastic, plexi-glass or the like. The mount 30a includes a slot 32a that retains one end of a bottom strap 34. The bottom right side of the covering includes a mount 30b that extends between the front and rear skate wheels preferably, but not necessarily, in like manner to mount 30a. The mount 30b is rigid and may be fabricated from a plastic, plexi-glass or the like. The mount 30b includes a slot 32b that is sized, adapted and/or configured to receive the other end of the strap 34 therethrough. The strap 34 has hook and loop material (e.g. Velcro®) thereon that allows the end of the strap 34 to be attached to itself when looped around the slot 32b and back towards slot 32a. In this manner, the bottom sides of the body 14 are held together underneath the skate 10.

In accordance with the principles of the present invention, the covering 12 includes a first circuit board 20a that is carried on the mount 30a on the bottom left side of the body 14 and a second circuit board 20b carried on the mount 30b on the bottom right side of the body 14. The circuit board 20a has a plurality of LEDs 22a situated along its length. While five (5) LEDs are shown, it should be appreciated that the number of LEDs may vary. In like manner, the circuit board 20b has a plurality of LEDs 22b situated along its length. Again, while five (5) LEDs are shown, it should be appreciated that the number of LEDs may vary. Also, the number of LEDs may be the same on each circuit board or may be different. The LEDs 22a, 22b may emit white light, a single color of light, or any combination of white and/or colored light. The LEDs 22a, 22b may also be multi-colored LEDs such as are known in the art. The circuit boards 20a, 20b have the necessary electrical components, circuitry, logic or the like to drive the LEDs. It should be appreciated that the LEDs 22a, 22b may be mounted onto something other than a circuit board or rigid mount. For instance, the LEDs may be mounted directly onto the material of the body of the covering.

As best seen in FIG. 4, a battery 42 retained in a battery clip 40 is used as a source of electricity and is disposed on the inside of the body 14. The battery 42 is shown as a typical nine (9) volt battery. It should be appreciated that other types, styles and/or voltages of batteries and/or more than one battery may be used to power the LEDs. The circuitry for the LEDs is adapted to utilize the chosen battery or batteries. The LEDs 22a, 22b are thus driven by DC voltage. A switch 46 is provided in the circuitry to turn the LEDs on and off. Wires 48 emanate from the circuitry/circuit board 20a and extend around the body 14 to connect to the circuitry/circuit board 20b. Preferably, and as shown, the wires 48 are sewn into or are provided within an inside covering of the body 14 in order to hide and/or protect the wires 48.

In one form, the circuitry/logic that drives the LEDs 22a, 22b functions to continuously light all of the LEDs 22a, 22b once turned on. Alternatively or additionally, the circuitry/logic may provide various modes of lighting of the LEDs 22a, 22b. Such modes of lighting may provide for continuous flashing of all or certain ones of the LEDs such as by color and/or position. Another mode may be a running or sequence mode whereby a first to last LED is turned on then off, and then repeats itself. Other modes may be derived from a combination of the above as well as other sequences as desired. Other modes are contemplated. Any one or all of these modes may be done for each bank of LEDs 22a and 22b at the same time or alternately.

FIG. 3 depicts an optional cover 25a that is situated over the LEDs 22a. The cover 25a is formed of a translucent or semi-translucent material in order to allow the light from the LEDs 22a to be seen there the cover 25a. The cover 25a extends from and along the mount 30a. Likewise, an optional cover 25b is depicted that is situated over the LEDs 22b. The cover 25b is formed of a translucent or semi-translucent material in order to allow the light from the LEDs 22b to be seen there the cover 25b. The cover 25b extends from and along the mount 30b. The covers 25a, 256b are not shown in FIG. 4 for clarity.

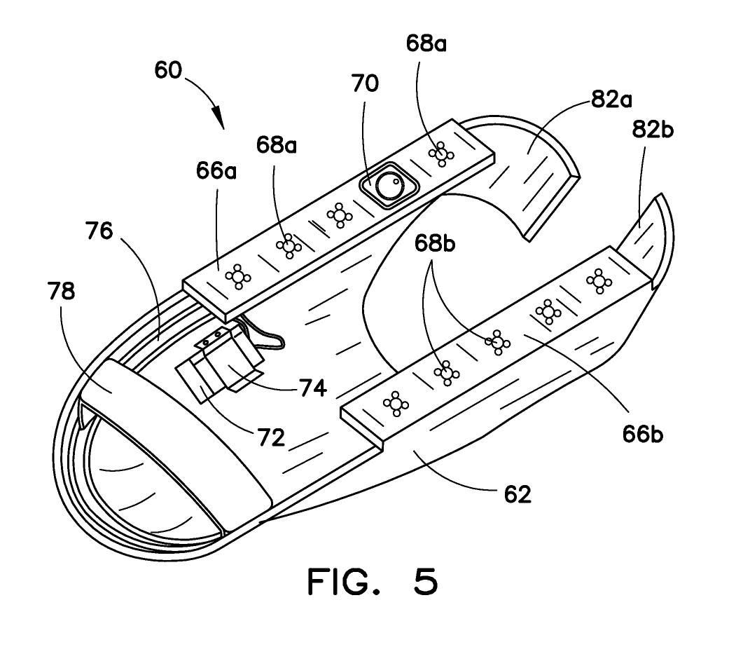

Referring now to FIG. 5, there is shown another embodiment of a covering 60 fashioned in accordance with the present principles. The covering 60 includes a rigid or semi-rigid body 62 that is shaped as a skate shoe. The body 62 may be thus formed of a flexible or rigid material such as plastic or the like. A toe strap 78 may be provided to help hold the body 62 onto the skate shoe. The body 62 has a left circuit board/mount 66a that extends transversely from a bottom left side of the body 62, and a right circuit board/mount 66b that extends transversely from a bottom right side of the body 62. The mounts 66a and 66b may be formed of the same material as the body 62 or may be formed of another material if desired. The back or heel of the body 62 is open to form a left end flap 82a and a right end flap 82b. The left and right end flaps 82a, 82b preferably, but not necessarily, include a closure mechanism to hold the flaps 82a, 82b together and retain the covering 60 onto the skate 10.

The mount 66a carries a plurality of LEDs 68a and an on/off switch 70. The mount 66b carries a plurality of LEDs 68b. While four (4) LEDs are shown on mount 66a, it should be appreciated that the number of LEDs may vary. The mount 66b has five (5) LEDs which is different in number than the number of LEDs 66a carried on the mount 66a. It should be appreciated that the number of LEDs may vary. The LEDs 66a, 66b may emit white light, a single color of light, or any combination of white and/or colored light. The LEDs 66a, 66b may also be multi-colored LEDs such as are known in the art. The circuit boards 60a, 60b have the necessary electrical components, circuitry, logic or the like to drive the LEDs. Moreover, while not shown in the embodiment of FIG. 5, covers like the covers 25a, 25b for the covering 12, may be situated over the LEDs 68a, 68b. Alternatively, the LEDs 68a, 68b may be recessed mounted in the mounts 66a, 66b with or without a cover for protection thereof. This may also apply to covering 12.

The underside of the body 62 carries a battery 72 retained in a battery clip 72 that is used as a source of electricity. The battery 72 is shown as a typical nine (9) volt battery. It should again be appreciated that other types, styles and/or voltages of batteries and/or more than one battery may be used to power the LEDs. The circuitry for the LEDs is adapted to utilize the chosen battery or batteries. The LEDs 66a, 66b are thus driven by DC voltage. Wires 76 emanate from the circuitry/circuit board/mount 60a and extend around the body 62 to connect to the circuitry/circuit board/mount 60b. Preferably, and as shown, the wires 48 are formed into or are provided within an inside covering of the body 62 in order to hide and/or protect the wires 76.

In one form, the circuitry/logic that drives the LEDs 66a, 66b functions to continuously light all of the LEDs 66a, 66b once turned on. Alternatively or additionally, the circuitry/logic may provide various modes of lighting of the LEDs 66a, 66b. Such modes of lighting may provide for continuous flashing of all or certain ones of the LEDs such as by color and/or position. Another mode may be a running or sequence mode whereby a first to last LED is turned on then off, and then repeats itself. Other modes may be derived from a combination of the above as well as other sequences as desired. Other modes are contemplated. Any one or all of these modes may be done for each bank of LEDs 66a and 66b at the same time or alternately.

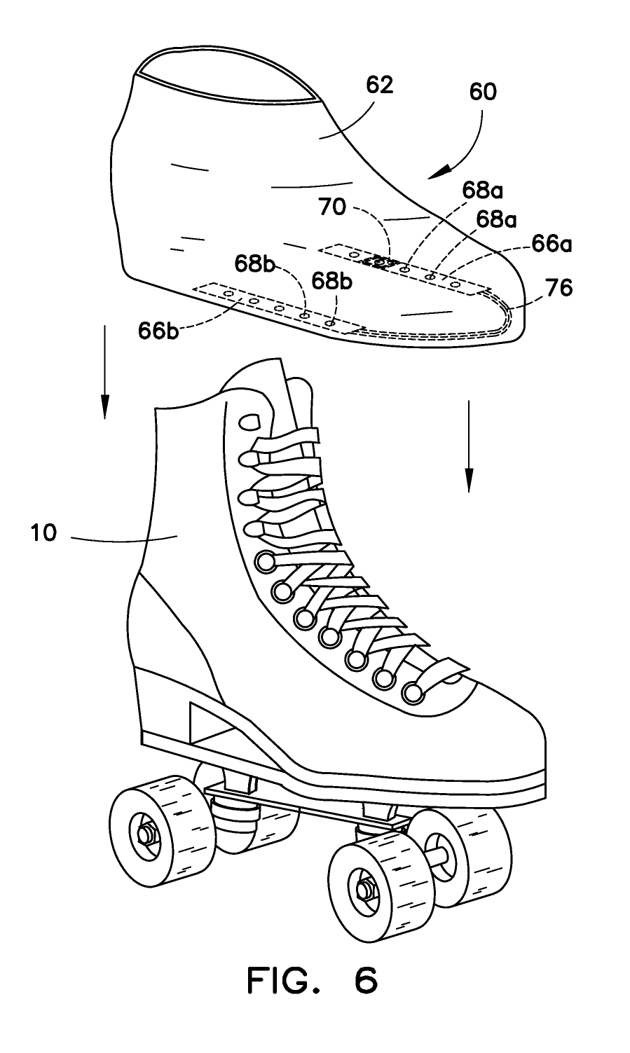

FIG. 6 depicts the manner in which the covering 60 is placed or received onto the skate 10. Because the covering 60 is rigid or at least semi-rigid, it fits down over the skate shoe. The toe of the body 62 is received over the toe of the shoe of the skate 10 while the back of the body 62 is closed around the heel of the skate 10.

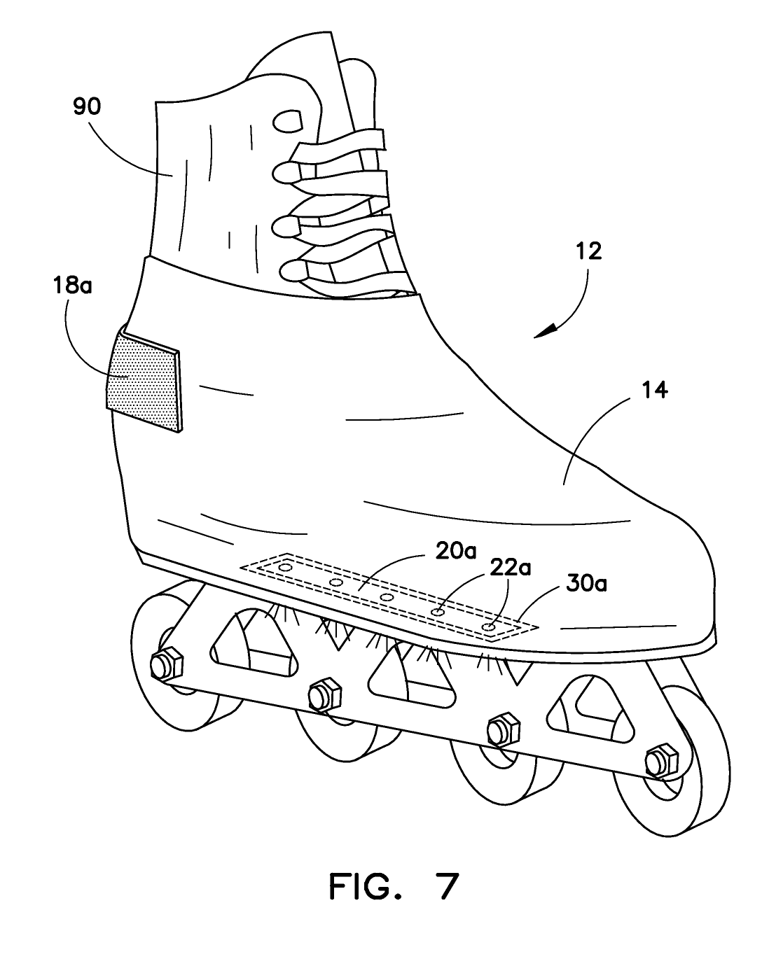

It should be appreciated that while not shown, the present LED skate covering may be used on other types of skates such as in-line skates, ice skates or the like. For example, FIG. 7 depicts the skate covering 12 on an in-line skate. The covering 12 is also shown without a protective toe piece or cover.

While the invention has been illustrated and described in detail in the drawings and foregoing description, the same is to be considered as illustrative and not restrictive in character, it being understood that only preferred embodiments have been shown and described and that all changes and modifications that come within the spirit of the invention are desired to be protected.

What is claimed is:

1. An illumination system for a roller skate, the illumination system comprising:
a body formed to removably cover and entirely surround a boot of a roller skate;
a first circuit board carried on a first bottom side of the body and parallel to a skating surface when the body is situated onto the boot of the skate;
a first plurality of LEDs carried on the first circuit board and situated thereon to direct light emanating therefrom downwardly toward the skating surface;
a second circuit board carried on a second bottom side of the body and parallel to the skating surface when the body is situated onto the boot of the skate;
a second plurality of LEDs carried on the second circuit board and situated thereon to direct light emanating therefrom downwardly toward the skating surface; and
circuitry associated with the first and second circuit boards and providing connection to the first and second plurality of LEDs to drive the first and second plurality of LEDs.

2. The illumination system of claim 1, wherein the body is formed of cloth.

3. The illumination system of claim 2, further comprising a rigid guard formed on a toe portion of the body.

4. The illumination system of claim 1, wherein the body is formed of a rigid material.

5. The illumination system of claim 4, wherein the rigid material is plastic.

6. The illumination system of claim 1, wherein the body is formed of a semi-rigid material.

7. The illumination system of claim 6, wherein the semi-rigid material is plastic.

8. The illumination system of claim 1, wherein the first and second plurality of LEDs are all one color.

9. The illumination system of claim 1, wherein the first and second plurality of LEDs are multiple colors.

10. The illumination system of claim 1, wherein the circuitry is adapted to provide various display modes of the first and second plurality of LEDs.

11. The illumination system of claim 1, further comprising a switch carried on an inside surface of the body and connected to the circuitry to turn the first and second plurality of LEDs on and off.

12. The illumination system of claim 1, wherein the first and second circuit boards extend between front and rear wheels of the roller skate.

13. An illumination system for a roller skate, the illumination system comprising:
a body configured to removably cover an entire lower boot portion of a boot of a roller skate;
a first circuit board situated on a first bottom side of the body and adapted to extend between a front wheel of the roller skate and a back wheel of the roller skate and be parallel to a skating surface when the body is situated onto the lower boot portion of the roller skate;
a first plurality of LEDs operatively connected to the first circuit board and situated thereon to direct light emanating therefrom downwardly toward the skating surface;
a second circuit board on a second bottom side of the body and adapted to extend between the front wheel of the roller skate and the back wheel of the roller skate and be parallel to a skating surface when the body is situated onto the lower boot portion of the roller skate;
a second plurality of LEDs operatively connected to the second circuit board and situated thereon to direct light emanating therefrom downwardly toward the skating surface; and
circuitry associated with the first and second circuit boards and providing connection to the first and second plurality of LEDs to drive the first and second plurality of LEDs.

14. The illumination system of claim 13 wherein the body is formed of cloth.

15. The illumination system of claim 13, wherein the body is formed of a rigid material.

16. The illumination system of claim 13, wherein the body is formed of a semi-rigid material.

17. An illumination device for a roller skate comprising:
a removable sheath configured to wrap entirely about a lower boot portion of a roller skate;
a first lighting system situated on a first bottom side of the sheath and configured to provide illumination of a skating surface, the first lighting system carrying a first plurality of LEDs;
a second lighting system situated on a second bottom side of the sheath and configured to provide illumination of the skating surface, the second lighting system carrying a second plurality of LEDs; and
circuitry connected to the first and second plurality of LEDs and adapted to drive and power the first and second plurality of LEDs.

18. The illumination device of claim 17, wherein the sheath is fabricated from cloth.

19. The illumination device of claim 17, wherein the sheath is fabricated from a semi-rigid material.

20. The illumination device of claim 17, wherein the sheath is fabricated from a rigid material.
